(19) United States
(12) Patent Application Publication
(10) Pub. No.: US 2026/0247486 A1
(43) Pub. Date: Aug. 20, 2026

(54) DYNAMIC LLI NEGOTIATION AND TXOP SCHEDULING FOR LLI

(71) Applicant: Samsung Electronics Co., Ltd., Suwon-si (KR)

(72) Inventors: Yue Qi, Plano, TX (US); Rubayet Shafin, Frisco, TX (US); Peshal Nayak, Plano, TX (US); Boon Loong Ng, Plano, TX (US); Vishnu Vardhan Ratnam, Frisco, TX (US); Bilal Sadiq, Plano, TX (US)

(21) Appl. No.: 19/537,257

(22) Filed: Feb. 11, 2026

Related U.S. Application Data
(60) Provisional application No. 63/758,573, filed on Feb. 14, 2025.
(60) Provisional application No. 63/767,318, filed on Mar. 5, 2025.
(60) Provisional application No. 63/767,367, filed on Mar. 5, 2025.
(60) Provisional application No. 63/836,117, filed on Jun. 30, 2025.

(51) Int. Cl. H04W 84/12; H04L 5/00

(52) U.S. Cl. CPC H04W 84/12; H04L 5/0053; H04L 5/0055

(57) ABSTRACT

Methods and systems for dynamic low latency indication (LLI) negotiation and transmission opportunity (TXOP) scheduling for LLI. A method includes generating a message including an LLI of pending buffered low latency traffic during a TXOP duration. The message includes a consideration indication configured to cause a TXOP initiator device to consider the LLI within the TXOP or in subsequent TXOP durations. The method also includes transmitting the LLI to a TXOP initiator device. Another method includes receiving, from a TXOP responder device, a message including an LLI of pending buffered low latency traffic during a TXOP duration. The method also includes generating a response including a result of the consideration of the LLI in response to the TXOP responder device. The method further includes transmitting the response to the TXOP responder device.

### CROSS-REFERENCE TO RELATED APPLICATIONS AND CLAIM OF PRIORITY

The present application claims priority to U.S. Provisional Patent Application No. 63/758,573, filed on Feb. 14, 2025; U.S. Provisional Patent Application No. 63/767,318, filed on Mar. 5, 2025; U.S. Provisional Patent Application No. 63/767,367 filed Mar. 5, 2025; and U.S. Provisional Patent Application No. 63/836,117, filed on Jun. 30, 2025. The contents of the above-identified patent documents are incorporated herein by reference.

### TECHNICAL FIELD

The present disclosure relates generally to wireless communication systems. more specifically, the present disclosure relates to systems and methods for dynamic low latency indication (LLI) negotiation and transmission opportunity (TXOP) scheduling for LLI.

### BACKGROUND

The latest generation of the WiFi standard, IEEE 802.11bn, places significant focus on reducing channel access delay for low-latency traffic required by real-time applications. At least one mode of operation is defined that is capable of improving the tail of the latency distribution and jitter compared to Extremely High Throughput MAC/PHY operation. Reducing latency to meet the increasing demand of real-time applications is therefore critical within IEEE 802.11bn.

### SUMMARY

The present disclosure relates generally to wireless communication systems and, more specifically, the present disclosure relates to a system and method for dynamic low latency indication (LLI) negotiation and transmission opportunity (TXOP) scheduling for LLI.

In one embodiment, a method is provided. The method includes generating a message including an LLI of pending buffered low latency traffic during a TXOP duration. The message includes a consideration indication configured to cause a TXOP initiator device to consider the LLI within the TXOP or in subsequent TXOP durations. The method also includes transmitting the LLI to a TXOP initiator device.

In another embodiment, a method is provided. The method includes receiving, from a TXOP responder device, a message including an LLI of pending buffered low latency traffic during a TXOP duration. The message includes a consideration configured to cause the TXOP initiator device to consider the LLI within the TXOP or in subsequent TXOP durations. The method also includes generating a response including a result of the consideration of the LLI in response to the TXOP responder device. The method further includes transmitting the response to the TXOP responder device.

In yet another embodiment, an electronic device is provided. The electronic device includes at least one processor including processing circuitry and a memory storing instructions. The instructions, when executed by the at least one processor individually or collectively, cause the electronic device to generate a message including an LLI of pending buffered low latency traffic during a TXOP duration. The message includes a consideration indication configured to cause a TXOP initiator device to consider the LLI within the TXOP or in subsequent TXOP durations. The instructions, when executed by the at least one processor individually or collectively, also cause the electronic device to transmit the LLI to a TXOP initiator device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIGS. 3A-3C illustrate example transmission diagrams of a pre-negotiation and quick indication supporting dynamic low latency indication (LLI) negotiation and transmission opportunity (TXOP) scheduling for LLI according to embodiments of the present disclosure;

FIGS. 4A-4D illustrate example transmission diagrams of dynamic LLI negotiation and TXOP scheduling for LLI with an implicit consideration indication according to embodiments of the present disclosure;

FIGS. 5A-5B illustrate example transmission diagrams of dynamic LLI negotiation and TXOP scheduling for LLI with an explicit consideration indication according to embodiments of the present disclosure;

FIG. 6 illustrates an example flow chart of a method for dynamic LLI negotiation and TXOP scheduling for LLI according to embodiments of the present disclosure; and

FIG. 7 illustrates an example flow chart of a method for dynamic LLI negotiation and TXOP scheduling for LLI according to embodiments of the present disclosure.

### DETAILED DESCRIPTION

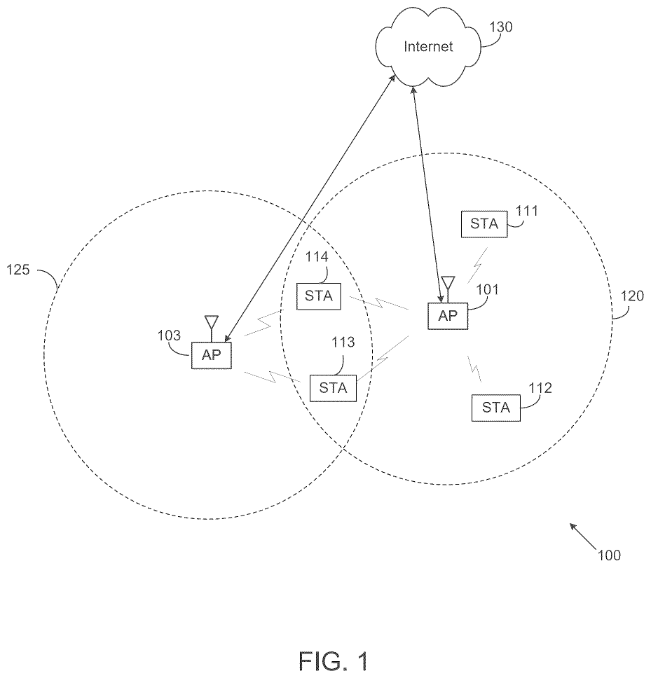

FIG. 1 through FIG. 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, the latest generation of the WiFi standard, IEEE 802.11bn, places significant focus on reducing channel access delay for low-latency traffic required by real-time applications. At least one mode of operation is defined that is capable of improving the tail of the latency distribution and jitter compared to Extremely High Throughput MAC/PHY operation. Reducing latency to meet the increasing demand of real-time applications is therefore critical within IEEE 802.11bn.

The need for IEEE 802.11bn arises from more stringent requirements to meet the demands of new applications, including metaverse, augmented and virtual reality, robotics, industrial automation for industrial IoT, logistics, and smart agriculture. Lower latency leads to better customer experience, with worst-case latency and jitter being particularly important. Low latency communication has become an essential building block for real-time applications. According to key performance indicator and Project Authorization Request discussions, some use cases require latency of less than 5 milliseconds and jitter of 2 milliseconds or less.

After the TXOP responder indicates low latency traffic, the TXOP initiator should consider the indication when determining subsequent actions within the current TXOP or subsequent TXOPs. However, the TXOP responder has no way of knowing whether the TXOP initiator considers the indication. Additionally, the TXOP responder has no visibility into the actions taken by the TXOP initiator. This lack of a feedback mechanism creates uncertainty, as the TXOP responder cannot determine whether the TXOP initiator actually considered the low latency indication. Furthermore, scheduling uncertainty arises because the TXOP responder has no visibility into how or when the TXOP initiator will schedule traffic based on the low latency indication.

Additionally, a significant amount of information may need to be delivered within the low latency indication, for example, access categories, traffic identifiers, user priorities, and urgency information. However, excessive information may increase overhead and may not be efficient to carry within a single control response frame. Additionally, there may not be enough reserved bits to include all low latency information in the control frame. Therefore, a negotiation procedure or preparation procedure may be considered before the TXOP or at the beginning of the TXOP, with only the most current information being updated during the TXOP.

Accordingly, the present disclosure provides systems and methods for dynamic LLI negotiation and TXOP scheduling for LLI. As described herein, the present disclosure includes systems and methods that includes generating a message including an LLI of pending buffered low latency traffic during a TXOP duration. The message includes a consideration indication configured to cause a TXOP initiator device to consider the LLI within the TXOP or in subsequent TXOP durations. The method also includes transmitting the LLI to a TXOP initiator device.

The present disclosure, thus, provides for methods and systems where part, most, or all LL information may be negotiated in any management frame or control frame, with dynamic low latency profiles typically negotiated before the TXOP or service period. Each low latency profile is defined as a set containing low latency traffic information and may include a profile identifier, the presence of an expiry time, a buffer status report, or an average low latency traffic duration. During the transmission phase, a low latency station may indicate the applicable low latency profile within the LL information. Through implicit indication, a TXOP responder may send LL information with a specified periodicity or continuousness, and the TXOP initiator may provide a lightweight acknowledgement in response. The TXOP responder may also request a portion of future transmission opportunities at the end of the previous TXOP. Through explicit indication, the TXOP initiator can send a frame specifying how and when the low latency traffic will be scheduled, for example, TXOP sharing or triggered uplink, including the starting time and duration of the shared TXOP. The TXOP initiator may explicitly inform the TXOP responder about the scheduling plan by acknowledging LL information and providing an estimated schedule or priority information.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for facilitating configuring a transmission for reception at an associated STA and an unassociated STA. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

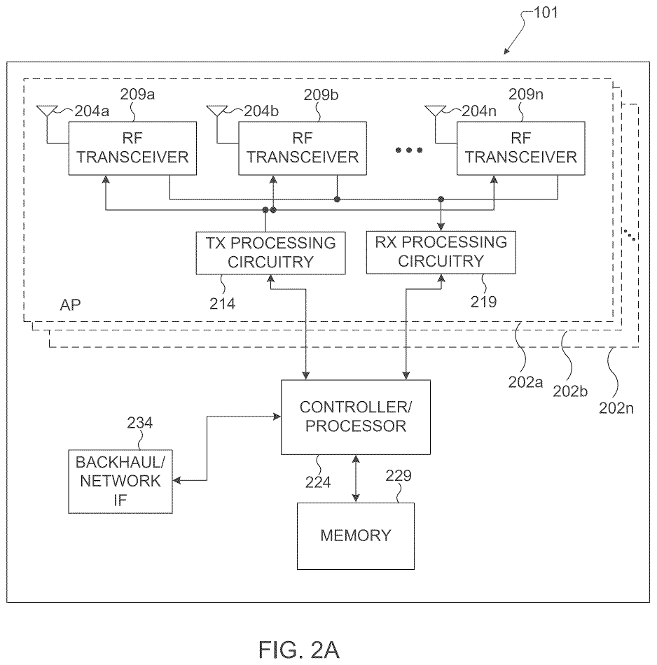

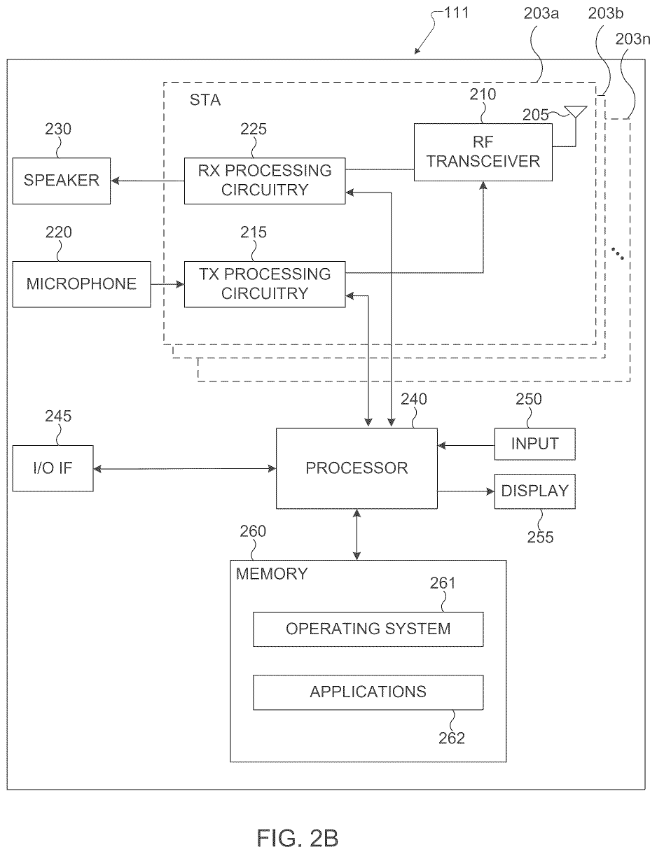

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHz, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating transmission for reception at an associated AP and an unassociated AP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for configuring a transmission for reception at an associated STA and an unassociated STA. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring a transmission for reception at an associated AP device and an unassociated AP device. In some embodiments, the controller/processor 240 includes at least one microprocessor or microcontroller.

The processor 240 is also capable of executing other processes and programs resident in the memory 260, such as operations for facilitating transmission for reception at an associated AP and an unassociated AP. The controller/processor 240 can move data into or out of the memory 260 as required by an executing process. In some embodiments, the controller/processor 240 is configured to execute a plurality of applications 262, such as applications for facilitating transmission for reception at an associated AP and an unassociated AP. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

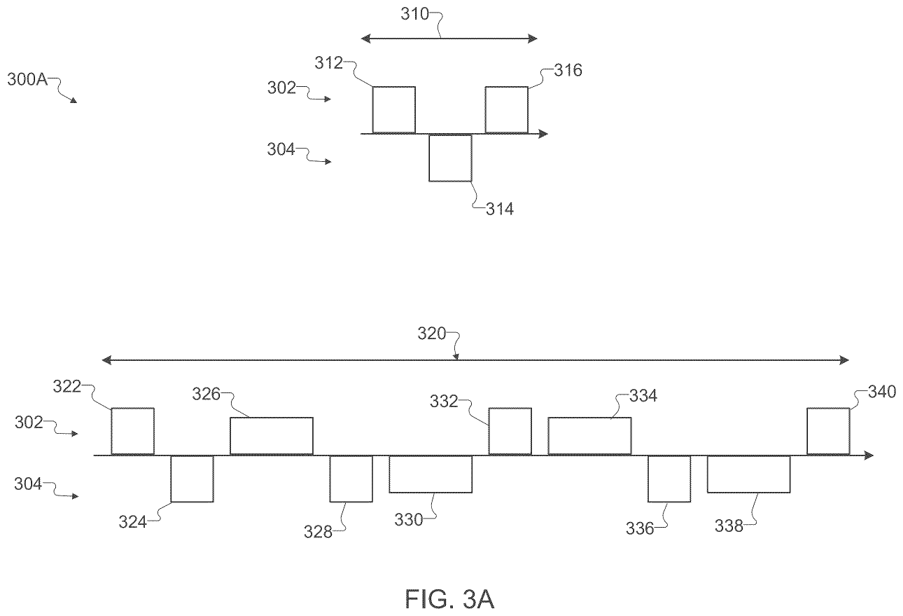

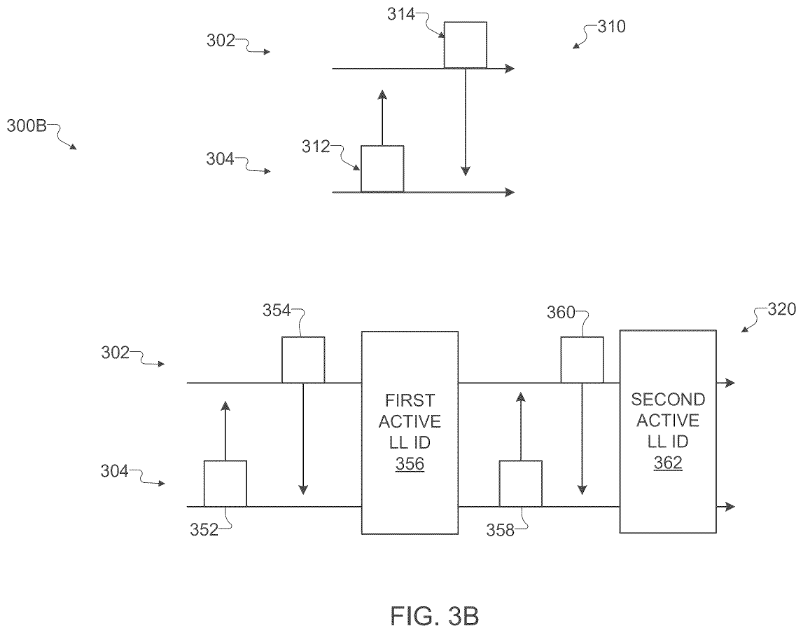

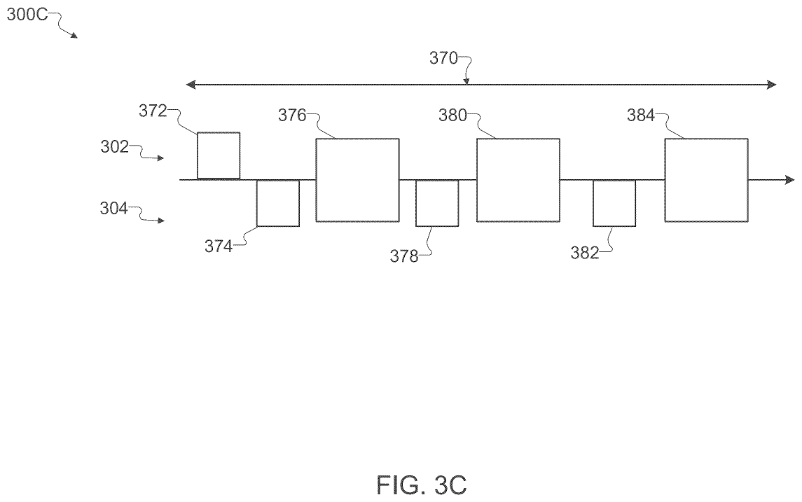

FIGS. 3A-3C illustrate example transmission diagrams 300A, 300B, 300C of a pre-negotiation and quick indication supporting dynamic LLI negotiation and TXOP scheduling for LLI according to embodiments of the present disclosure. In particular, FIG. 3A illustrates a transmission diagram 300A supporting pre-negotiation and quick indication, FIG. 3B illustrates a transmission diagram 300B supporting dynamic LL frame exchange, and FIG. 3C illustrates a transmission diagram 300C supporting a TXOP frame exchange. For ease of explanation, the transmission diagrams 300A, 300B, 300C will be described as including one or more components of the wireless network 100 of FIG. 1, such as the APs 101, 103 and the STAs 111-114; however, the transmission diagrams 300A, 300B, 300C could be implemented using any other suitable device or system. The embodiment of the transmission diagrams 300A, 300B, 300C shown in FIGS. 3A-3C is for illustration only. Other embodiments of the transmission diagrams 300A, 300B, 300C could be used without departing from the scope of this disclosure.

As shown in FIG. 3A, the transmission diagram 300A includes a negotiation phase 310 and a TXOP phase 320. The negotiation phase 310 includes a negotiation between a TXOP responder 304 (such as one of the STAs 111-114) and a TXOP initiator 302 (such as the AP 101 or the AP 103). For example, the TXOP responder 304 may receive a request frame 312, respond with a response frame 314, and receive a confirmation frame 316. Additionally, the TXOP phase 320 may, for example, include the TXOP responder 304 receiving a management frame 322 (such as a request to send (RTS) frame), responding with a responding management frame 324 (such as a clear to send (CTS) frame), receiving a data frame 326, and responding with a first block acknowledgement (BA) 328. The TXOP responder 304 may also transmit a first low latency (LL) data frame 330 to the TXOP initiator 302 and receive an acknowledgement frame 332. The frame exchange may proceed with a second iteration, which may include the TXOP responder 304 receiving a second data frame 334, transmitting a second BA 336 and a second LL data frame 338, and, subsequently, receiving a second acknowledgement frame 340.

As shown, LL information may be negotiated during the negotiation phase 310 before the TXOP phase 320 or before a series of TXOPs. Additionally, the LL information may be negotiated during the TXOP phase 320 or at the beginning of the TXOP phase 320 in any control frame. Most or all of the LL information may be negotiated between a TXOP initiator 302 and a TXOP responder 304, such as between a reverse direction (RD) initiator and an RD responder, between an AP and a non-AP STA associated with the AP, or between a non-AP STA and a peer STA that may support the LLI during the TXOP or any service period (SP).

Some dynamic low latency profiles are negotiated before the TXOP phase 320 or service period in the negotiation phase 310. The LL profile is defined as a set containing LL traffic (LLT) information, and each profile may include an LL profile identification (ID). For example, all possible low latency access categories (ACs), all latency-sensitive traffic identifiers (TIDs), and other LL information may be negotiated or carried in the negotiation phase 310. Each combination may be named as a specific LL ID. For example, an LL profile with an ID equal to 1 may include a specific set of AC, AID, TID, stream classification service (SCS) identification (ID), and similar parameters. During the next or more subsequent TXOPs, or during the next few transmissions or SPs, one, two, or more LL IDs are indicated in the control frame, which suggests the needs of the LL traffic.

With respect to negotiation frames, the LL information, such as that in Table 1, in the negotiation phase 310 may be included in association, reassociation, probe request frames, beacons, and other management frames (such as the management frame 324 and the responding management frame 326).

TABLE 1
Low Latency Information Items in the Negotiation Phase.

| Information items | Description |
|---|---|
| AC | The ACs are negotiated during the negotiation phase in which the STA |
| | with potential LL traffic may indicate |
| UP and TID | A set of UPs and or TIDs are negotiated for LLT. |
| SCS ID | A set of SCS ID profiles are set and negotiated. |
| QoS Char. Element | One or some or full subfields in the QoS Char, Element that related to |
| | the LLT may be included in the negotiation phase. |
| LL bandwidth or RU | This is to negotiate the bandwidth that is used for LLT and may also |
| | negotiate a specific or reserved RU for LLT. |
| Average LLT | An information item indicates the average duration of LLT in one |
| duration | TXOP or service period. |
| Average LLT | An information item indicates the average frequency of LLT in a TXOP |
| frequency | or service period. |
| Average enqueue | An average enqueue time is negotiated or indicated to provide an |
| time | expectation of the enqueue time of the LLT. |
| Average expiration | An average expiration time is negotiated to provide an expectation of |
| time | the end time of the LLT. |
| Average of | An average remaining time is negotiated to provide an expectation of |
| remaining time to | the remaining time to expiration of the LLT. It may indicate the delay |
| expiration | when it was enqueued until it was scheduled. |
| Maximum LLT | An information item indicates the maximum duration of LLT in one |
| duration | TXOP or service period. The STA, when negotiating, may make sure |
| | there is no LLT and may exceed the duration in the following TXOPs. |
| Most tolerant delay | An average expiration time is negotiated to provide an expectation of |
| bounds | the end time of the LLT. |
| AP or TXOP | An information item includes all the actions that how the AP or the |
| initiator's response | TXOP may react to the LL indication. Each policy may be encoded. |
| or feedback policy | |
| Enqueue time | An average enqueue time is negotiated to provide an expectation of the |
| | enqueue time of the LLT. |
| Timing to Expiration | Timing to Expiration specifies the time duration from current time (T1) |
| report | to the transmission expiration time (T2) for an MSDU or A-MSDU. |
| Remaining time to | Remaining time is indicated to provide an expectation of the remaining |
| expiration | time to expiration of the LLT. It may indicate the delay when it was |
| | enqueued until it was scheduled. |

In one embodiment, the LL information, such as that in Table 1, in the negotiation phase 310 may be included in the SCS request and response frame 314. In one embodiment, the LL information in the negotiation frames can be the multi-link (ML) reconfiguration frames, the Operation Mode and Parameters (OMP) update frames, or any management frames or Action frames. The LL information may be requested or enabled in management frames, such as SCS and OMP frames. A field that indicates the LLI, such as an LLI request subfield, may be included in the management frames.

As shown in FIG. 3B, the transmission diagram 300B includes the TXOP responder 304 transmitting a first dynamic LL request frame 352 during the TXOP phase 320 and receiving a first LL response frame 354 from the TXOP initiator 302. The TXOP initiator 302 and the TXOP responder 304 then enter a first active LL ID 356. This process may be subsequently repeated, for example, by the TXOP responder 304 transmitting a second LL request 358 to the TXOP initiator 302, receiving a second LL response 360, and then entering into a second active LL ID 362 with the TXOP initiator 302.

The TXOP responder 304 may send a dynamic LL request frame 352 during the negotiation phase 310. For example, the TXOP initiator 302 (such as an AP) may respond to the dynamic LL request frame 352 with a dynamic LL response frame 354, where the LL response frame 354 may indicate accept, reject, change, or similar actions. When the LL response frame 354 indicates code accept in the following TXOP, such as in a reverse direction grant (RDG) and other protocols, and when the TXOP responder 304 indicates the corresponding LL profile or LL IDs that have been agreed upon in the negotiation phase 310, the TXOP initiator 302 may switch or update the LL profile during the TXOP and activate the LL transmission with such LL profile.

As shown in FIG. 3C, the transmission diagram 300C includes a TXOP duration 370 in which the TXOP responder 304 transmits an ICF 372 to the TXOP initiator 302 and receives a CRF 374 before initiating a traffic exchange 376 that does not include LLT. Upon receiving LLT for transmission, the TXOP responder 304 may transmit to the TXOP initiator 302 a first BA 378 which includes an LLI before entering a first LL traffic exchange 380. This may be repeated as necessary, for example, by the TXOP responder 304 transmitting a second BA 382 with a second LLI to the TXOP initiator 302 to enter into a second LL traffic exchange 384.

The TXOP initiator 302 may send a request frame (such as an ICF 372) and poll the dynamic LL request from the TXOP responder 304. In one embodiment, the TXOP responder 304 may transmit a CRF 374 to the TXOP initiator 302 by indicating the LL profile IDs and any agreements on the information. The TXOP initiator 302 then may transmit a confirmation frame to the TXOP responder 304. In one embodiment, the negotiation phase 310 may consider some or all of the information in Table 1. In one embodiment, the above subfields may be included in the QoS Characteristics Elements of an SCS request and CRF 374. In one embodiment, the negotiation frames can be the ML reconfiguration frames, the Operation Mode and Parameters update frames, or any management frames or Action frames.

In one embodiment, a matrix can be considered to encode the above information. For example, the first row of the matrix contains AC parameters, the second row contains the UP and TIDs, and the last row contains the TXOP initiator 302 or TXOP initiator 302's response or feedback policy. For example, a vector of LL-profile ID may be described as follows: AC, UP, TID, T of Mvg_LLT, Avg enqueue time, and AP reaction policy. If there is no specific difference throughout the next few TXOPs, a void or omitted element can be considered. For example, if all the ACs will be AC_VO for LLT, then that row can be omitted until requested.

With respect to information carried in the TXOP phase 320, in one embodiment, the TXOP responder 304 may include the LL profile ID in the control CRF 374, such as multi-STA BA. The LL profile ID may include a subset of the information in Table 1. In one example of the embodiment, an LL profile may include information such as AC with AC_VO, UP and TID set as UP=2 and TID=7, and average duration. In a different transmission during the TXOP, another LL profile may include information such as AC with AC_VI, UP and TID set as UP=2 and TID=6, and average duration, which was also agreed upon in the negotiation phase 310.

Turning to the semi-static negotiation procedure, in one embodiment, during the TXOP or the SP, when there is a need for LL indication, part of the LL information, the LL profile, or an indication of buffered low latency traffic can be dynamically switched or updated instead of using the full list of information. Additionally or alternatively, some of the LL information is negotiated to include a common or semi-static set of LL information, such as AC_VO, mean value of latency bounds, and any special TIDs, for LL traffic. Additional information such as urgency information may not be available in the negotiation phase 310 but is indicated in the control frame during the TXOP.

With respect to negotiation frames in the semi-static context, in one embodiment, the LL information for aperiodic or dynamic traffic or preemption utilization may be included in the SCS with QoS Characteristics. For example, dynamic QoS may include the low latency traffic profile. In one embodiment, the LL information in the negotiation may be included in association, reassociation, probe request frames, beacons, and other management frames.

With respect to information carried in the semi-static negotiation frame, in one embodiment, the semi-static negotiation may consider some or all of the information in Table 2.

TABLE 2
Information items in the semi-static phase.

| Information items | Description |
|---|---|
| AC | The default AC of the LL traffic is AC_VO. If there is a need of |
| | indicating AC_VI in the control frame during the TXOP, a bit 1 can be |
| | indicated to show a special need of changing or adjusting the ACs. |
| UP and TID | A specific UP and or TID is negotiated for LLT in default. If there is a |
| | need of indicating a different set of UP and TID, a bit 1 can be indicated |
| | to show the adjusting on the UP and or TID. |
| SCS ID | The SCS IDs can be negotiated during the TXOP phase. If there is a |
| | need of indicating a different SCS ID, a bit 1 can be indicated. |
| LL bandwidth or | This is to negotiate the bandwidth that is used for default LLT and may |
| RU | also negotiate a specific or reserved RU for LLT. If there is a need of |
| | changing the bandwidth or reserved RU, a bit 1 can be indicated. |
| The average | An information item indicates the average duration of LLT in one TXOP |
| duration of the LL | or service period. The information may be updated by the real-time LLT |
| traffics | during the transmission. |
| The maximum | An information item indicates the maximum duration of LLT in one |
| duration of the LLT | TXOP or service period. The a-periodic LLT may not exceed the |
| | duration. |
| AP or TXOP | An information item includes part of the actions that how the AP or the |
| initiator's response | TXOP may react to the LL indication. If there is a need of indicating a |
| or feedback policy | different set of actions, encoding bits or values can be indicated to show |
| | the adjusting actions. |
| Enqueue time | An average enqueue time is negotiated to provide an expectation of the |
| | enqueue time of the LLT. |
| Timing to | Timing to Expiration specifies the time duration from current time (T1) |
| Expiration report | to the transmission expiration time (T2) for an MSDU or A-MSDU. |
| Remaining time to | Remaining time is indicated to provide an expectation of the remaining |
| expiration | time to expiration of the LLT. It may indicate the delay when it was |
| | enqueued until it was scheduled. |

This phase may include urgency information such as delay bounds, expiration time, remaining time to expiration, and enqueue time.

Regarding information carried in the TXOP phase 320, the information carried during the transmission can be considered using frames, such as the first and second multi-STA BA frame 378, 382. A specific Per AID TID Info may carry information in addition to the common information. For example, by using reserved bits or exchanging certain information fields, such as Block Ack Starting sequence control, the AID TID Info indicates the value of AP policy. The urgency information is included in the Per AID TID field.

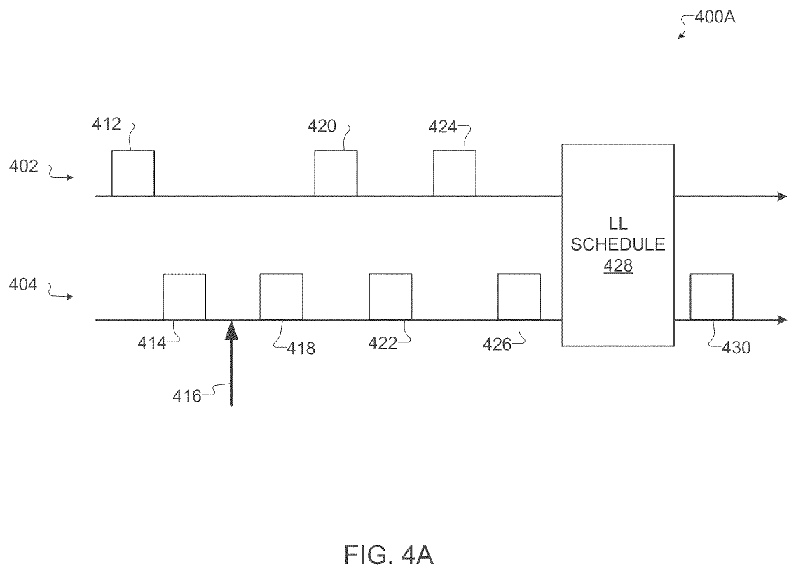

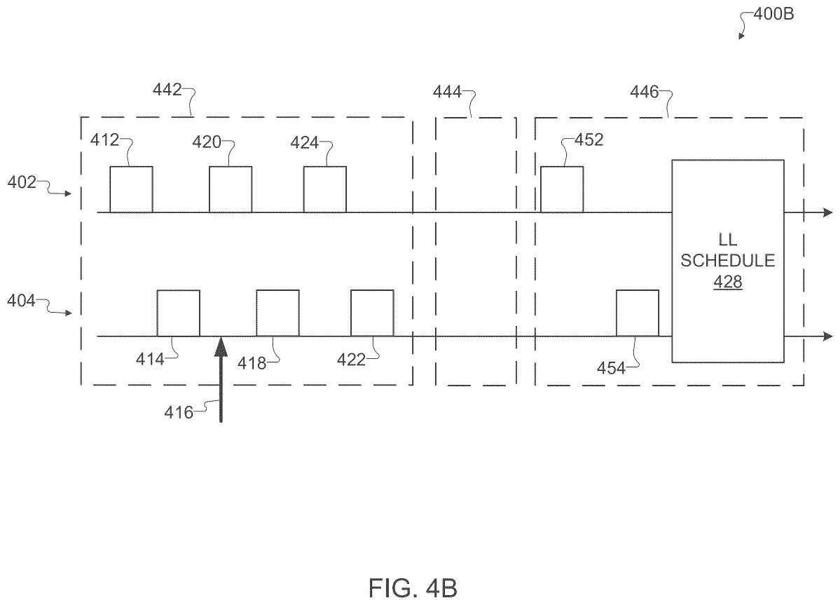

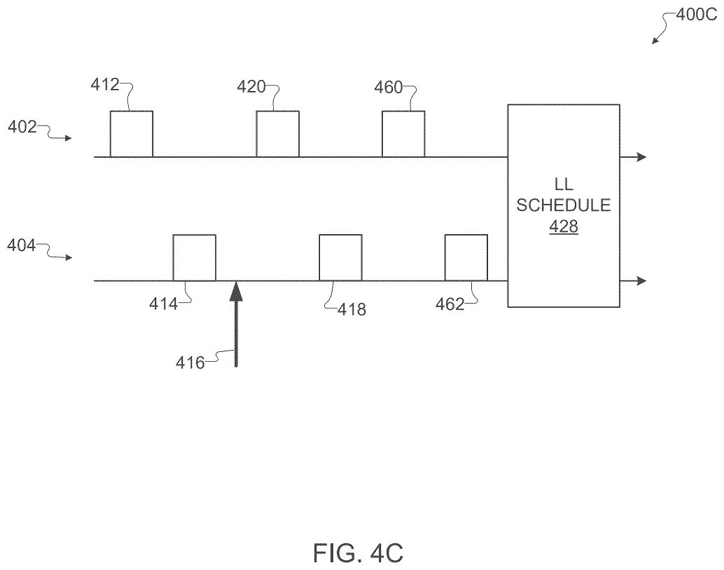

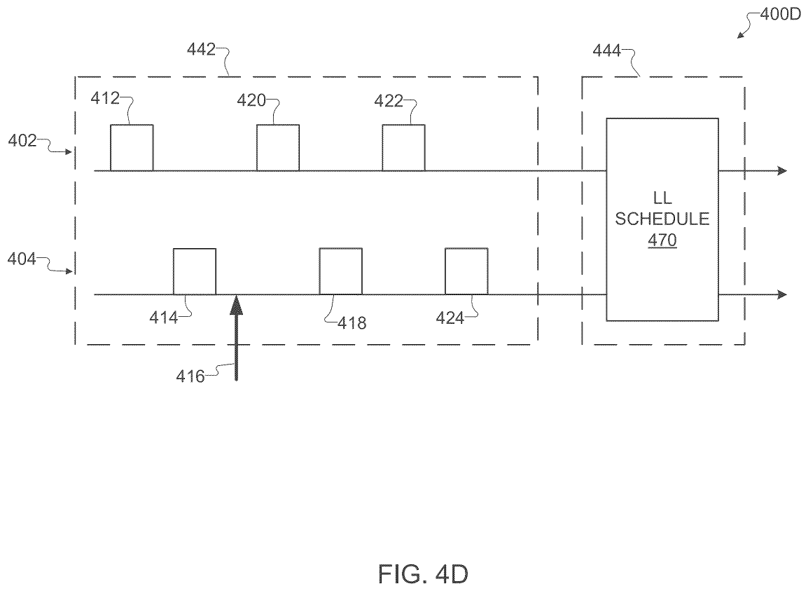

Although FIGS. 3A-3C illustrate example transmission diagrams 300A, 300B, 300C of a pre-negotiation and quick indication supporting dynamic LLI negotiation and TXOP scheduling for LLI, various changes may be made to FIGS. 3A-3C. For example, various components of FIGS. 3A-3C could be combined, further subdivided, or omitted and additional components could be added according to particular needs. Additionally, the transmission diagrams may include as shown in FIGS. 4A-4D.

FIGS. 4A-4D illustrate example transmission diagrams 400A, 400B, 400C, 400D of dynamic LLI negotiation and TXOP scheduling for LLI with an implicit consideration indication according to embodiments of the present disclosure. In particular, FIG. 4A illustrates a transmission diagram 400A supporting pre-negotiation and quick indication, FIG. 4B illustrates a transmission diagram 400B, 4C illustrates a transmission diagram 400C, and FIG. 4D illustrates a transmission diagram 400D. For ease of explanation, the transmission diagrams 400A, 400B, 400C, 400D will be described as including one or more components of the wireless network 100 of FIG. 1, such as the APs 101, 103 and the STAs 111-114; however, the transmission diagrams 400A, 400B, 400C, 400D could be implemented using any other suitable device or system. The embodiments of the transmission diagrams 400A, 400B, 400C, 400D shown in FIGS. 4A-4D are for illustration only. Other embodiments of the transmission diagrams 400A, 400B, 400C, 400D could be used without departing from the scope of this disclosure.

As shown in FIG. 4A, the transmission diagram 400A includes a frame exchange between a TXOP initiator 402 (such as the AP 101 or the AP 103) and a TXOP responder 404 (such as one of the STAs 111-114). For example, the TXOP initiator 402 may transmit a request frame 412 (such as an RTS) to the TXOP responder 404, which responds with a response frame 414 (such as a CTS). The TXOP responder 404 may receive LLT 416 during the frame exchange and may generate and transmit a first LL BA 418 with an LLI to the TXOP initiator 402. If the TXOP initiator 402 does not provide an acknowledgement and instead transmits, for example, a data frame 420, the TXOP responder 404 may send a second LL BA 422 with the LLI. This process may be repeated as necessary if, for example, the TXOP initiator 402 does not transmit an acknowledgement of the LLI and instead transmits a data frame 424. In such examples, the TXOP responder 404 may transmit a third LL BA 426 to the TXOP responder 404 until the LLT is scheduled (such as during an LL schedule 428). The TXOP responder 404 may respond to the scheduling, for example, with a BA 430.

After the TXOP responder 404 indicates low latency traffic, the TXOP initiator 402 should consider this indication when determining subsequent actions within the current TXOP or subsequent TXOPs. However, two significant issues arise in this context. First, no guarantee or visibility exists for the TXOP responder 404. Second, no method or assurance exists to protect subsequent actions. These limitations create a potential problem where low latency traffic may not receive prioritization as intended across multiple TXOPs.

The problem of the TXOP initiator 402 not acknowledging the LLI may be potentially solved if the TXOP responder 404 provides urgency information to the TXOP initiator 402 so that the TXOP initiator 402 would know the urgency of the LLT 416 and can schedule accordingly. This method would increase the probability that the LLT 416 at the TXOP responder 404 side can be considered and scheduled by the TXOP initiator 402.

In one embodiment, the TXOP responder 404 may include the urgency information in the LLI of the first LL BA 418, such as delay bounds, expiration time, or enqueue time. The urgency information may provide the TXOP initiator 402 with enough information to decide subsequent actions. Additionally or alternatively, the TXOP responder 404 may include the maximum waiting time in the first LL BA 418.

A second solution involves repeated LLI in multiple frame types. Under this approach, the TXOP responder 404 may send the LLI frame continuously in each block acknowledgement until the low latency traffic receives full service. The TXOP responder 404 may indicate low latency periodically, and the periodicity, ending time, and maximum number of frames can be negotiated when the TXOP starts. Repeated LLI may also be sent in multiple frame types.

A variation of this second solution involves continuous LLI. The LLI may be modified to include an extended validity period, allowing the indication to remain valid beyond a single TXOP. The LLI may provide information to the TXOP initiator 402 for a valid period, which may fall within the delay bounds. A new field may be introduced in the indication from the TXOP responder 404 to specify the duration for which low latency traffic should be prioritized. A periodic or continuous LLI may be considered if no subsequent actions, acknowledgement, or rejection occur from the TXOP initiator 402. The following LLI may indicate buffered low latency traffic needs with a bit field. For example, if the bit for buffered low latency equals one, a continued and constant need exists for low latency traffic to be scheduled, for example, through target wake time. If the bit for buffered low latency equals zero, or the field is disabled, no pending buffered low latency traffic or needs exist from the TXOP responder 404 side.

As such, the TXOP responder 404 may send the LLI continuously in each BA until the LLT 416 is fully served. Additionally or alternatively, the TXOP responder 404 may indicate the LLT 416 periodically. The periodicity, ending time, and maximum number of frames can be negotiated when the TXOP starts. Once the first LLI is transmitted, a periodic or continuous LLI may be considered if there are no subsequent actions, acknowledgement, or rejection from the TXOP initiator 402. When the first LLI in the first LL BA 418 is transmitted and the TXOP initiator 402 does not initiate the transmission, the TXOP responder 404 may keep sending the LL information in the following BAs, such as the second LL BA 422 and the third LL BA 426.

Additionally or alternatively, the continuous LL BAs may update the urgency information. For example, the subsequent LLIs may update the timing information, such as the delay bounds. Additionally or alternatively, as shown in Table 3, the subsequent LLIs may update the wait retries with a countdown value. The subsequent LLIs may indicate the buffered LL traffic needs with a bit field. For example, if the bit for buffered LL equals one, there is a continued and constant need for LLT 416 to be scheduled. If the bit for buffered LL equals zero, or the field is disabled, there is no pending buffered LLT 416 or needs from the TXOP responder 404 side.

TABLE 3
Indication of Ongoing LLT

| Information Item | Description and Encoding |
|---|---|
| Buffered LL field | A bit indicates if the buffered LL is still in the waiting to be |
| | transmitted. If the bit equals to one, it indicates a continued need. If |
| | the bit equals to zero, it indicates no pending buffered LLT or needs |
| | any more. |
| Waiting retries | A bit indicates if the buffered LL is still waiting to be transmitted. A |
| | countdown value may be updated each time when BA is transmitted. |
| | If the countdown value equals to one, it means the LL needs is no |
| | longer required. |

Additionally or alternatively, the LLI may include an extended validity period, a valid period for the pending buffered traffic, or both. The LLI may specify the duration for which the LLT 416 should be prioritized. Further, the LLI including such duration or period may extend beyond a single TXOP. The LLI may indicate the valid period or protected prioritized duration to the TXOP initiator 402. For example, the protected prioritized duration may be shorter than the valid period with expiration time.

As shown in FIG. 4B, the transmission diagram 400B may include a plurality of TXOPs 440 between the TXOP initiator 402 and the TXOP responder 404. For example, the plurality of TXOPs 440 may include a first TXOP 442, a second TXOP 444, and a third TXOP 446. The transmission diagram 400B illustrates a frame exchange in which LLT is not scheduled within the same TXOP duration and needs to be scheduled in a subsequent TXOP duration. For example, the TXOP responder 404 may transmit the first LL BA 418 after receiving the LLT 416 and then transmit the second LL BA 422 upon receiving the data frame 420 rather than an acknowledgement from the TXOP responder 404 at the end of the first TXOP 442. In such cases, the TXOP responder 404 may retain the LLT 416 until a subsequent TXOP and resend the LLI in, for example, a second CTS 454 in response to a second RTS 452. This may occur in TXOP durations immediately after the initial TXOP in which the LLT arrived or in subsequent TXOP durations. For example, the TXOP responder 404 may transmit the second CTS 454 to the TXOP responder 404 during the third TXOP 446 if the second TXOP 444 is unavailable (such as if the second TXOP 444 is obtained by other STAs).

According to one embodiment, the TXOP responder 404 may continue sending the LLI before expiration by including the LLI in other frames, such as control frames, BA, and response frames 414. For example, the TXOP responder 404 may repeatedly embed the LLI in various frame types to maintain persistent LL awareness. The BA frame carries the LLI when acknowledging any ongoing transmission, while the response frame 414 ensures LL awareness when another TXOP begins. The QoS null data frame allows an explicit LL reminder without data transmission, and data frames embed the LLI as part of ongoing communication. These frame examples ensure persistent awareness of the LL requirement across TXOPs, reduce uncertainty, and ensure dedicated time for the LLT 416.

For example, if the LLT 416 arrives in the middle of first TXOP 442, the TXOP responder 404 is prompted to send the first LLI in a multi-STA BA (such as the first LL BA 418). However, the TXOP initiator 402 may not schedule the LLT 416. In such a case, the TXOP responder 404 indicates an ongoing LLI in a subsequent BA, which serves as the second LLI. If the TXOP responder 404 still requires an indication in subsequent TXOPs, the TXOP responder 404 may indicate those needs in a control response frame, such as response frame 414, until the LLT 416 is scheduled or expires.

According to one embodiment, if the TXOP initiator 402 is an AP, the TXOP initiator 402 may store and propagate the LLI across multiple TXOPs. The TXOP initiator 402 may prioritize the LLI by adjusting contention parameters or TXOP duration and may also schedule a specific TXOP for LLT 416 from the TXOP responder 404. If the first TXOP 442 does not provide an opportunity to schedule the transmission, the TXOP initiator 402 may reserve a future TXOP for LLT 416, such as the third TXOP 446. According to one embodiment, a short LL-reserved frame or the last BA may indicate the next TXOP, which will be prioritized for LLT 416.

Additionally or alternatively, if the next TXOP initiator 402 is the current TXOP holder, that holder may fulfill the promise to schedule the LLT 416. If the next TXOP initiator 402 is another STA and the TXOP responder 404 is not involved, the process may proceed through AP management. Otherwise, the TXOP responder 404 may need to wait until the previous TXOP initiator 402 obtains the TXOP again.

According to one embodiment, the TXOP responder 404 and the TXOP initiator 402 may have an agreement regarding how many subsequent TXOPs or what timeout period applies before the TXOP responder 404 may be scheduled. Under this arrangement, the TXOP responder 404 knows in advance when the LLT 416 will be scheduled.

As shown in FIG. 4C, the transmission diagram 400C includes a frame exchange in which the TXOP initiator 402 provides the TXOP responder 404 an acknowledgement upon receiving the LLI. For example, the TXOP responder 404 may transmit the first LL BA 418 to the TXOP initiator 402. In response, the TXOP initiator 402 may transmit a data frame with a low latency response (LLR) 460 that includes an LLI acknowledgement bit (LLI Ack bit). In such cases, the TXOP responder 404 may simply transmit an acknowledgement 462 rather than re-transmit the LLI. The TXOP initiator 402 may then schedule the LLT for transmission.

In one embodiment, the TXOP initiator 402 may provide a lightweight ACK to the TXOP responder 404 in response to the LLI. For example, the LLR 460 to the LLI represents a value that addresses feedback or requests from the TXOP responder 404. A bit field, such as the LLI Ack bit field, may indicate whether the LLI has been considered. The TXOP initiator 402 can embed a single bit, with the LLI Ack bit equal to 1, in any existing frames, such as QoS Data, BA, request frame 412, or response frame 414.

In one embodiment, the TXOP responder 404 may monitor these frames to determine whether the LLI was considered. For example, if the LLI Ack bit is set to 1, the TXOP responder 404 may expect certain actions from the TXOP initiator 402. Policies governing such actions can be negotiated ahead of time or indicated in existing frames. If the TXOP responder 404 determines that the bit LLI Ack is set to zero, the LL request was not considered by the TXOP initiator 402 in the current TXOP.

In another embodiment, the TXOP responder 404 may receive from the TXOP initiator 402 information regarding the schedule of the pending LLT 416. For example, the TXOP initiator 402 may indicate performance of a request frame 412 TXS sharing or may indicate an RDG protocol with RDG equal to 1. If no ACK frame with LLI is received or the LLI Ack bit is set to zero within a specified period, the TXOP responder 404 assumes the request was ignored.

TABLE 4
Implicit Feedback from TXOP Holder

| Information Item | Description and Encoding |
|---|---|
| LLI Ack field | A bit field in response to the LLI. If the TXOP initiator considers the |
| | LLI, it may be set as 1, otherwise, set as zero. |
| Policies and actions | A value indicates the policies or actions that the TXOP initiator plan |
| | to schedule. For example, a value equals to 1 indicates a P2P |
| | transmission policy by sending RTS TXS. A value equals to 2, |
| | indicates a reversed direction transmission for UL from TXOP |
| | responder, etc. |

The LLI Ack bit can be extended beyond a single binary acknowledgement to include additional information through an extra bit or field. When the LLI Ack bit equals 1, the LLT 416 has been acknowledged and scheduled. The LLI Ack bit may also equal 1 with an accompanying Priority Bit or urgency information, indicating that the LLT 416 has been acknowledged and will be prioritized sooner. When the LLI Ack bit equals 0, the request was not considered and a retry is needed. The LLI Ack bit may alternatively equal 0 with a Reschedule Request, indicating that the LLT 416 has not been scheduled yet but will be deferred to a next available TXOP, target wake time (TWT), or preemption window.

As shown in FIG. 4D, the transmission diagram 400D includes a frame exchange in which the LLT is scheduled in a first TXOP for transmission in a second TXOP. For example, the TXOP responder 404 may transmit a second LL BA 422 to the TXOP initiator 402. The TXOP initiator 402 may respond in the first TXOP 442 with scheduling the LLT for transmission in the second TXOP 444 using a LLT schedule 470.

The transmission diagram 400D illustrates a further TXOP request mechanism that allows a TXOP responder 404 to request a portion of future TXOPs at the end of a previous TXOP. For example, the TXOP responder 404, upon detecting incoming LLT 416, sends an LLI during an ongoing TXOP (such as the first TXOP 442) but the LLT 416 is not scheduled by the TXOP initiator 402. The TXOP responder 404 still requires the LLT to be scheduled and sends another LLI in the last frame the TXOP responder 404 sends of the TXOP.

Rather than relying solely on the current TXOP initiator 402 to schedule the LLT 416, the TXOP responder 404 may request a full or partial allocation of future TXOPs. A subsequent TXOP (such as the second TXOP 444) is not necessarily owned by the current TXOP initiator 402 and could instead be managed by another device (such as a separate AP) in infrastructure mode or allocated by a future TXOP initiator 402 who can assign a portion of the subsequent TXOP to the TXOP responder 404. This approach ensures the LLT 416 gets scheduled even if the current TXOP initiator 402 does not have enough time or resources to allocate within first TXOP 442.

Additionally or alternatively, the TXOP initiator 402 may be involved in the TXOP allocation for LLT 416. The TXOP initiator 402 can take an active role in scheduling future TXOPs to ensure LLT 416 is delivered in a timely manner. When the TXOP responder 404 indicates LLT 416 within an ongoing TXOP, the TXOP initiator 402 monitors and records the request. If the current TXOP initiator 402 is unable to immediately serve the TXOP responder 404, the TXOP initiator 402 can intervene by ensuring that a portion of a future TXOP (such as the second TXOP 444) is allocated to the TXOP responder 404.

The TXOP initiator 402 achieves this by dynamically managing TXOP allocations through one of several mechanisms. For example, the TXOP initiator 402 may use TXOP scheduling or TWT in beacon or control frames. The TXOP initiator 402 periodically transmits a TXOP scheduling within beacon frames or a dedicated quality-of-service control frame, indicating which stations have upcoming TXOP allocations. If a TXOP responder 404 has pending LLT 416, the TXOP initiator 402 ensures that a portion of the next available TXOP is assigned to that station.

The TXOP initiator 402 can also provide a mediated TXOP grant scheme. If a new TXOP is obtained by another station (such as in the second TXOP 444), the TXOP initiator 402 can instruct that station to allocate a portion of the second TXOP 444 to the TXOP responder 404. This can be achieved by embedding a TXOP grant message within control frames, such as RTS or CTS frames including the request frame 412 and the response frame 414, or BA frames.

By leveraging centralized coordination, AP-assisted TXOP allocation effectively reduces scheduling uncertainty, minimizes retransmissions, and ensures that LLT 416 is not starved due to contention delays. This approach is particularly beneficial in dense networks where stations frequently compete for medium access, helping to maintain predictable low latency performance.

To address fairness considerations and prevent abuse, mechanisms can be added to limit the frequency of TXOP reservations. The AP or stations can adjust enhanced distributed channel access (EDCA) parameters to balance fairness and low latency scheduling needs.

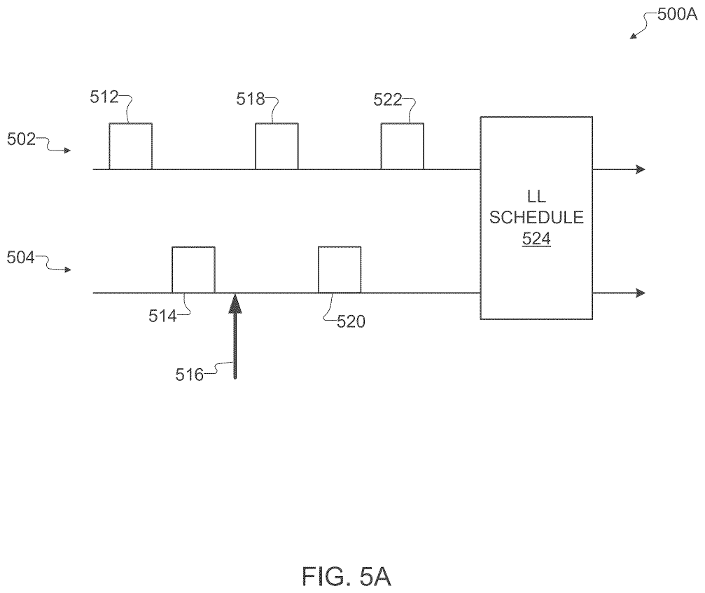

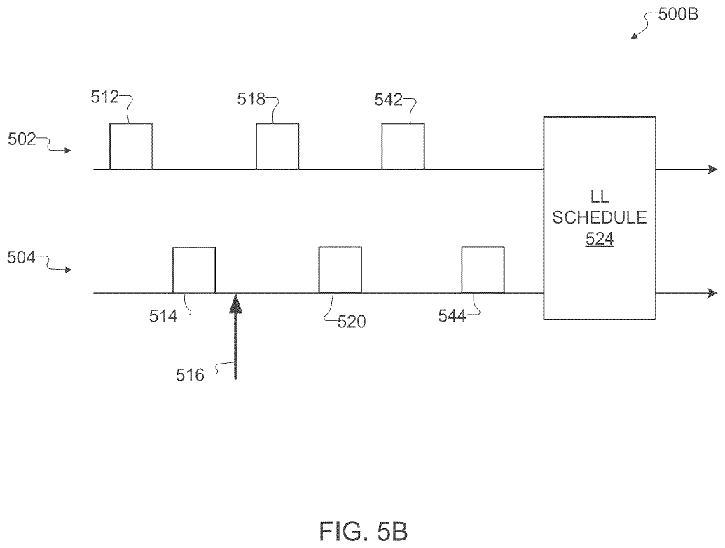

Although FIGS. 4A-4D illustrate an example flow diagram of dynamic LLI negotiation and TXOP scheduling for LLI with an implicit consideration indication, various changes may be made to FIGS. 4A-4D. For example, various components of FIGS. 4A-4D could be combined, further subdivided, or omitted and additional components could be added according to particular needs. Additionally, the TXOP initiator response may include an explicit acknowledgement to the LLI. as shown in FIGS. 5A-5B.

FIGS. 5A-5B illustrate example transmission diagrams 500A, 500B of dynamic LLI negotiation and TXOP scheduling for LLI with an explicit consideration indication according to embodiments of the present disclosure. For ease of explanation, the transmission diagrams 500A, 500B will be described as including one or more components of the wireless network 100 of FIG. 1, such as the APs 101, 103 and the STAs 111-114; however, the transmission diagrams 500A, 500B could be implemented using any other suitable device or system. The embodiment of the transmission diagrams 500A, 500B shown in FIGS. 5A-5B are for illustration only. Other embodiments of the transmission diagrams 500A, 500B could be used without departing from the scope of this disclosure.

As shown in FIG. 5A, the transmission diagram 500A is a frame exchange between a TXOP initiator 502 and a TXOP responder 504. For example, the TXOP initiator 502 may transmit a request frame 512 (such as an RTS) to the TXOP responder 504, which responds with a response frame 514 (such as a CTS). The TXOP responder 504 may receive a LLT 516 before receiving a data frame 518 from the TXOP initiator 502. The TXOP responder 504 may then transmit a BA 520 that includes an LLI. The TXOP initiator 502 may respond with an ICF 522 acknowledging the LLI and preparing an LLT schedule 524.

As shown in FIG. 5A, the TXOP initiator 502 may explicitly inform the TXOP responder 504 about the scheduling plan. This mechanism allows the TXOP initiator 502 to explicitly acknowledge LLI by scheduling the LLT 516 and providing an estimated schedule or priority information.

When the TXOP responder 504 sends an LLI, the TXOP responder 504 requests scheduling feedback from the TXOP initiator 502. For example, if the TXOP responder 504 indicates am upload (UL) transmission or P2P transmission in the LLI and requests an immediate action from the TXOP initiator 502 in the request frame 512, the TXOP initiator 502 may transmit an initial control frame. such as MU-RTS TXS, as the response frame 514 for either UL transmission or P2P transmission. For example, an ICF is used by the TXOP initiator 502 to inform the TXOP responder 504 of the schedule.

To do so, the TXOP responder 504 may send an LLI within an MBA, BA, QoS null, or Data frame. The TXOP initiator 502 receives the LLI and determines how to schedule LLT 516, including the duration, resources, and the manner in which the TXOP responder 504 requests service or can be served.

The TXOP initiator 502 may use an ICF as the response frame 514, such as MU-RTS or RTS, to begin scheduling. Additionally or alternatively, the response frame 514 may also include the scheduling plan in response to the TXOP responder 504 in cases where the response frame 514 serves another purpose. An LLI response or acknowledgement frame may be incorporated into the response frame 514.

The TXOP responder 504, upon receiving the response frame 514 from the TXOP initiator 502, may extract the header or the LL Ack information field to determine when to expect LLT 516 transmission or whether a reattempt is needed.

Additionally or alternatively, a control response frame may be included before any schedule. If LLT 516 is scheduled, the TXOP responder 504 follows up with a confirmation. If LLT 516 is not scheduled in the current TXOP, the TXOP responder 504 may wait and avoid unnecessary retries until enough time has passed to reattempt. The scheduling policy actions may include an LLT 516 acknowledgement field, an LLT 516 schedule indicator, and an LLT 516 scheduling plan. The information that may be considered in the ICF can be found in Table 5.

TABLE 5
ICF with Scheduling Plan and in Response to LLT

| Information item | Description and encoding |
|---|---|
| LLT Ack Field | A field indicates if the TXOP initiator has received the LLI and considered |
| | it or not. For example, a LLI Ack bit equals to 1, indicates that the TXOP |
| | initiator will consider the scheduling of the LLT from the responder in the |
| | next data PPDU. |
| LLT Schedule | A field indicates the LLT scheduling plan. For example, 00 indicates that |
| Indicator | the LLT is not scheduled. 01 indicates the LLT is scheduled in the |
| | following PPDU. 10 indicates the LLT is scheduled in the next few PPDU |
| | or in the next TXOP instead of an immediate data PPDU. 11 indicates the |
| | LLT may be deferred to next subsequent TXOPs. |
| LLT Scheduling | The specific scheduling may be decided by the AP or the TXOP initiator, |
| Plan | while they may also provide the list that how they intend to operate. For |
| | example, if MU-RTS for UL/P2P is considered. A value 1 is considered. |
| | If RDG is in the list, a value 2 is considered. If no such action or the action |
| | is out of the scope, a value 0 is considered. |

As shown in FIG. 5B, the transmission diagram 500B is a frame exchange between the TXOP initiator 502 and the TXOP responder 504. The transmission diagram 500B is configured similarly to the transmission diagram 500A, except that, instead of responding with an ICF 522, the TXOP initiator 502 responds with an LLR 542, indicating a that the TXOP initiator 502 will schedule the LLT 516 for transmission at a later point. The TXOP responder 504, may respond with an acknowledgement 544.

To address delayed scheduling for LLT 516, the TXOP initiator 502 can send a frame that specifies how and when the LLT 516 will be scheduled. Within the frame, the methods that the TXOP initiator 502 may consider are listed in the LLT 516 scheduling plan in Table 5. As a variant of this example, an LLT 516 schedule frame serving as a dedicated control frame may announce the LLT 516 scheduling. This approach prevents uncertainty regarding the LLI and avoids potential redundant LLI retransmission. For example, the TXOP initiator 502 may announce a scheduled transmission time, ensuring clarity for the TXOP responder 504.

To do so, the TXOP responder 504 may send an LLI, and the TXOP initiator 502 receives the LLI but may not immediately schedule the transmission. In response to the TXOP responder 504, the TXOP initiator 502 explicitly or implicitly announces the LLT 516 schedule using one of several policies. For example, an MU-RTS policy applies when there is UL or P2P transmission at the TXOP responder 504. An RDG policy grants a scheduled UL opportunity for the TXOP responder 504 by including the RDG/More PPDU field, and once the TXOP initiator 502 sets data with RDG equal to 1, the RD starts. The LLT 516 TWT or shared TXOP policy provides the exact time and duration when the LLT 516 will be scheduled within the current TXOP or subsequent TXOPs. Example signaling is shown in Table 6.

TABLE 6
ICF with Scheduling Plan and in Response to LLT

| Information Item | Description and Encoding |
|---|---|
| Scheduled | Indicates the duration that LLT will be assigned. |
| Duration | |
| Scheduled Start | Indicates the start time that LLT will be assigned in the future. |
| Time | |
| Scheduled | Indicates the medium time that LLT will be assigned in the future. |
| Medium Time | |

The TXOP responder 504 may wait for the scheduled TXOP. After receiving the scheduling frame, the TXOP responder 504 does not need to send multiple LLI transmissions unless an update is needed. The LLT 516 transmission occurs according to the scheduled announcement.

According to another embodiment, a modified BA, an additional control frame, or an extension of an existing frame can be considered. For example, the TXOP initiator 502 may send an LL Acknowledgement Frame (LL-ACK) after receiving an LLI. This frame may confirm receipt of the LLI and optionally include a TXOP scheduling intent indicating that LLT 516 is scheduled in the next TXOP. For example, this may indicate that LLT 516 will be scheduled with priority, or alternatively that LLT 516 is not scheduled in the current TXOP and that the TXOP responder 504 should reattempt.

Although FIGS. 5A-5B illustrate an example flow diagram of dynamic LLI negotiation and TXOP scheduling for LLI with an explicit consideration indication, various changes may be made to FIGS. 5A-5B. For example, various components of FIGS. 5A-5B could be combined, further subdivided, or omitted and additional components could be added according to particular needs.

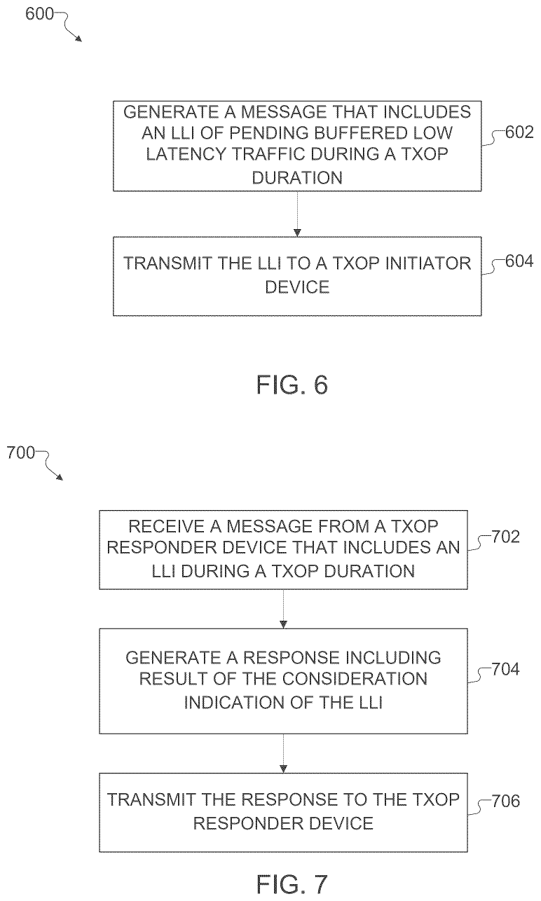

FIG. 6 illustrates an example method 600 for dynamic LLI negotiation and TXOP scheduling for LLI according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of dynamic LLI negotiation and TXOP scheduling for LLI could be used without departing from the scope of this disclosure.

As shown in FIG. 6, a message is generated that includes an LLI of pending buffered low latency traffic during a TXOP duration at step 602. For example, the TXOP responder 404 may, in response to receiving the LLT 416, generate a first LL BA 418 that includes an LLI of the LLT 416. Additionally or alternatively, the TXOP responder 404 may generate sequential messages, such as a second LL BA 422, to transmit to the TXOP initiator 402.

The LLI is transmitted to a TXOP initiator device at step 604. For example, the TXOP responder 404 may transmit the first LL BA 418 that includes the LLI to the TXOP responder 404. Additionally or alternatively, the TXOP responder 404 may sequentially transmit the LLI in subsequent BAs, such as the second LL BA 422 or the third LL BA 426, until the TXOP responder 404 receives an implicit or explicit acknowledgement from the TXOP initiator 402, such as the LL schedule 428 or the LLR 460.

Although FIG. 6 illustrates one example method for dynamic LLI negotiation and TXOP scheduling for LLI, various changes may be made to FIG. 6. For example, while shown as a series of steps, various steps in FIG. 6 could overlap, occur in parallel, occur in a different order, or occur any number of times.

FIG. 7 illustrates an example method 700 for dynamic LLI negotiation and TXOP scheduling for LLI according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of dynamic LLI negotiation and TXOP scheduling for LLI could be used without departing from the scope of this disclosure.

As shown in FIG. 7, a message is received from a TXOP responder device that includes an LLI of pending buffered low latency traffic during a TXOP duration at step 702. For example, the TXOP initiator 402 may receive a first LL BA 418 with an LLI from the TXOP responder 404.

A response is generated that includes a result of the consideration indication of the LLI in response to the TXOP responder device at step 704. For example, the TXOP initiator 402 may generate an explicit acknowledgement of the first LL BA 418 and may schedule the LLT using the LL schedule 428. Additionally or alternatively, the TXOP responder 404 may transmit a LLR 460 for later scheduling.

The response is transmitted to the TXOP responder device at step 706. For example, the TXOP initiator 402 may transmit the LL schedule 428 or the LLR 460 to the TXOP responder 404.

Although FIG. 7 illustrates one example method for dynamic LLI negotiation and TXOP scheduling for LLI, various changes may be made to FIG. 7. For example, while shown as a series of steps, various steps in FIG. 7 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a transmission opportunity (TXOP) responder device, the method comprising:
generating a message including a low latency indication (LLI) of pending buffered low latency traffic during a TXOP duration, wherein the message includes a consideration indication configured to cause a TXOP initiator device to consider the LLI within the TXOP or in subsequent TXOP durations; and
transmitting the LLI to a TXOP initiator device.

2. The method of claim 1, wherein the consideration indication includes urgency information and configured to cause the TXOP initiator device to schedule the low latency traffic based on the urgency information.

3. The method of claim 1, wherein the consideration indication is an implicit acknowledgement at the TXOP initiator device.

4. The method of claim 3, wherein the implicit acknowledgement includes:
a determination of whether the LLI from the TXOP responder has been considered; or
a further TXOP request such that the TXOP responder device requests a portion of subsequent TXOP durations after the TXOP duration.

5. The method of claim 3, wherein the implicit acknowledgement is configured to cause the TXOP initiator device to transmit an acknowledgement frame appending to any data frame transmitted to the TXOP responder device.

6. The method of claim 1, wherein the consideration is an explicit acknowledgement indication at the TXOP initiator.

7. The method of claim 6, wherein the explicit acknowledgement comprises a scheduling feedback request from the TXOP initiator device configured to cause the TXOP responder device to transmit an acknowledgement frame.

8. The method of claim 7, wherein the acknowledgement frame is (i) contained in an ICF configured to schedule the low latency traffic or (ii) contained in a separate scheduling frame containing a delayed schedule for the low latency traffic.

9. A method performed by a transmission opportunity (TXOP) initiator device, the method comprising:
receiving, from a TXOP responder device, a message including a low latency indication (LLI) of pending buffered low latency traffic during a TXOP duration, wherein the message includes a consideration indication configured to cause the TXOP initiator device to consider the LLI within the TXOP or in subsequent TXOP durations;
generating a response including a result of the consideration indication of the LLI in response to the TXOP responder device; and
transmitting the response to the TXOP responder device.

10. The method of claim 9, wherein the consideration indication includes urgency information and configured to cause the TXOP initiator device to schedule the low latency traffic based on the urgency information.

11. The method of claim 9, wherein the consideration indication is an implicit acknowledgement at the TXOP initiator device.

12. The method of claim 11, wherein the implicit acknowledgement includes:
a determination of whether the LLI from the TXOP responder has been considered; or
a further TXOP request such that the TXOP responder device requests a portion of subsequent TXOP durations after the TXOP duration.

13. The method of claim 11, wherein the implicit acknowledgement is configured to cause the TXOP initiator device to transmit an acknowledgement frame appending to any data frame transmitted to the TXOP responder device.

14. The method of claim 9, wherein the consideration is an explicit acknowledgement indication at the TXOP initiator.

15. The method of claim 14, wherein the explicit acknowledgement comprises a scheduling feedback request from the TXOP initiator device configured to cause the TXOP responder device to transmit an acknowledgement frame.

16. The method of claim 15, wherein the acknowledgement frame is (i) contained in an ICF configured to schedule the low latency traffic or (ii) contained in a separate scheduling frame containing a delayed schedule for the low latency traffic.

17. An electronic device comprising:
at least one processor including processing circuitry; and
a memory storing instructions, wherein the instructions, when executed by the at least one processor individually or collectively, cause the electronic device to:
generating a message including a low latency indication (LLI) of pending buffered low latency traffic during a TXOP duration, wherein the message includes a consideration indication configured to cause a TXOP initiator device to consider the LLI within the TXOP or in subsequent TXOP durations; and
transmitting the LLI to a TXOP initiator device.

18. The electronic device of claim 17, wherein the consideration indication includes urgency information and configured to cause the TXOP initiator device to schedule the low latency traffic based on the urgency information.

19. The electronic device of claim 17, wherein consideration indication is an implicit acknowledgement at the TXOP initiator device and the implicit acknowledgement includes:
a determination of whether the LLI has been considered; or
a further TXOP request such that the electronic device requests a portion of subsequent TXOP durations after the TXOP duration.

20. The electronic device of claim 17, wherein the consideration is an explicit acknowledgement indication at the TXOP initiator and the explicit acknowledgement comprises a scheduling feedback request from the TXOP initiator device configured to cause the electronic device to transmit an acknowledgement frame.
